(19) United States
(12) Patent Application Publication
(10) Pub. No.: US 2025/0149027 A1
(43) Pub. Date: May 8, 2025

(54) METHOD AND DEVICE WITH SPEECH PROCESSING

(71) Applicants: Samsung Electronics Co., Ltd., Suwon-si (KR); Seoul National University R&DB Foundation, Seoul (KR)

(72) Inventors: Nam Soo KIM, Seoul (KR); Ji Won YOON, Seoul (KR)

(73) Assignees: Samsung Electronics Co., Ltd., Suwon-si (KR); Seoul National University R&DB Foundation, Seoul (KR)

(21) Appl. No.: 18/903,676

(22) Filed: Oct. 1, 2024

(30) Foreign Application Priority Data
Nov. 7, 2023 (KR) 10-2023-0152826

(51) Int. Cl. G10L 15/183; G10L 15/06; G10L 15/22

(52) U.S. Cl. CPC G10L 15/183; G10L 15/063; G10L 15/22

(57) ABSTRACT

A method of processing speech includes: obtaining a speech input; obtaining an instruction related to the speech input; obtaining a speech representation corresponding to the speech input; obtaining an adapter that includes speech information by fusing a pre-trained adapter with the speech representation; and obtaining a response corresponding to the instruction by inputting both the adapter that includes the speech information and the instruction to a language model, the language model generating the response based on the adapter that includes the speech model and the speech information.

### CROSS-REFERENCE TO RELATED APPLICATIONS

This application claims the benefit under 35 USC § 119 (a) of Korean Patent Application No. 10-2023-0152826, filed on Nov. 7, 2023, in the Korean Intellectual Property Office, the entire disclosure of which is incorporated herein by reference for all purposes.

### BACKGROUND

### 1. Field

The following description relates to a method and device with speech processing, and more particularly, to a general-purpose method of processing speech using a language model.

### 2. Description of Related Art

In the field of natural language processing, large language models (LLMs) have been applied to various tasks using a natural language instruction. LLMs have shown excellent performance.

Recently, the expansion from a natural language instruction to a multi-modal instruction has attracted attention, and particularly, research on an LLM with the addition of a visual reasoning function is being conducted.

Furthermore, in addition to visual content, research on an LLM capable of understanding video content by adding audio to an instruction is being conducted.

Existing multi-modal LLMs have a limitation in that they may include an audio-related task (e.g., audio event detection) but may not process a speech-related task. For example, an existing multi-modal LLM cannot contain content related to how a speaker feels, what a speaker is speaking, or how many speakers there are in a response by receiving a speech instruction. To perform speech instruction tuning, it may be helpful to configure an encoder specifically for speech and then generate and train a new dataset.

The above description has been possessed or acquired by the inventor(s) in the course of conceiving the present disclosure and is not necessarily an art publicly known before the present application is filed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method of processing speech includes: obtaining a speech input; obtaining an instruction related to the speech input; obtaining a speech representation corresponding to the speech input; obtaining an adapter that includes speech information by fusing a pre-trained adapter with the speech representation; and obtaining a response corresponding to the instruction by inputting both the adapter that includes the speech information and the instruction to a language model, the language model generating the response based on the adapter that includes the speech model and the speech information.

The adapter that includes the speech information and the pre-trained adapter may have a same length.

The obtaining of the adapter that includes the speech information may include: inputting the pre-trained adapter as a query of a multi-head attention; inputting the speech representation as a key-value to the multi-head attention; and determining an output of the multi-head attention to be the adapter that includes the speech information.

The pre-trained adapter may have a fixed-length, and the speech representation may have a variable length.

The speech representation may be obtained by inputting the speech input to a speech encoder.

The response may include, with respect to the speech input, a speech recognition, a speech emotion recognition, a speaker recognition, a speech translation, or colloquial language understanding related to the speech input.

In another general aspect, a training method includes: obtaining a speech input; obtaining an instruction generated based on the speech input and a labeled response; obtaining a speech representation corresponding to the speech input; obtaining an adapter that includes speech information by fusing an adapter and the speech representation; obtaining a response corresponding to the instruction by inputting the adapter that includes the speech information and the instruction to a language model that generates the response corresponding to the instruction; and training the adapter based on the labeled response and the response corresponding to the instruction.

The speech representation may be obtained by inputting the speech input to a speech encoder that generates the speech representation, the speech representation representing features of the speech input.

The language model and the speech encoder may be pre-trained models.

The adapter that includes the speech information and the adapter fused with the speech representation may have a same length.

The obtaining of the adapter that includes the speech information may include: inputting the adapter as a query of multi-head attention; inputting the speech representation as a key-value of the multi-head attention; and determining an output of the multi-head attention to serve as the adapter that includes the speech information.

The adapter may have a fixed-length, and the speech representation may have a variable length.

A non-transitory computer-readable storage medium may store instructions that, when executed by a processor, cause the processor to perform any of the methods.

In another general aspect, a device for processing speech includes: a speech encoder configured to receive a speech input and configured to encode the speech input as a speech representation corresponding to the speech input; a fusion model configured to output an adapter that includes speech information by fusing a pre-trained adapter and the speech representation; and a language model configured to receive an instruction related to the speech input and the adapter including the speech information, the language model configured to output a response corresponding to the instruction.

The adapter that includes the speech information and the pre-trained adapter may have a same length.

The fusion model may be configured to: receive the pre-trained adapter as a query of a multi-head attention; receive the speech representation as a key-value of the multi-head attention; and output an output of the multi-head attention to the adapter including the speech information.

The pre-trained adapter may have a fixed-length, and the speech representation may have a variable length.

Other features and aspects will be apparent from the following detailed description, the drawings, and the claims.

### BRIEF DESCRIPTION OF THE DRAWINGS

FIG. 1 illustrates an example of a speech processing system, according to one or more embodiments.

FIG. 2A illustrates an example of a deep learning operation method using a neural network, according to one or more embodiments.

FIG. 2B illustrates an example of a training and inference method of a neural network model, according to one or more embodiments.

FIG. 3 illustrates an example of a structure of a speech processing device, according to one or more embodiments.

FIG. 4 illustrates an example of an operation of an adapter fusion model, according to one or more embodiments.

FIG. 5 illustrates an example of a speech processing method, according to one or more embodiments.

FIG. 6 illustrates an example of a training method, according to one or more embodiments.

FIG. 7 illustrates an example of a configuration of an electronic device, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

The examples may be implemented as various types of products, such as, for example, a personal computer (PC), a laptop computer, a tablet computer, a smartphone, a television (TV), a smart home appliance, an intelligent vehicle, a kiosk, and a wearable device, as non-limiting examples. Hereinafter, examples will be described in detail with reference to the accompanying drawings. In the drawings, like reference numerals are used for like elements.

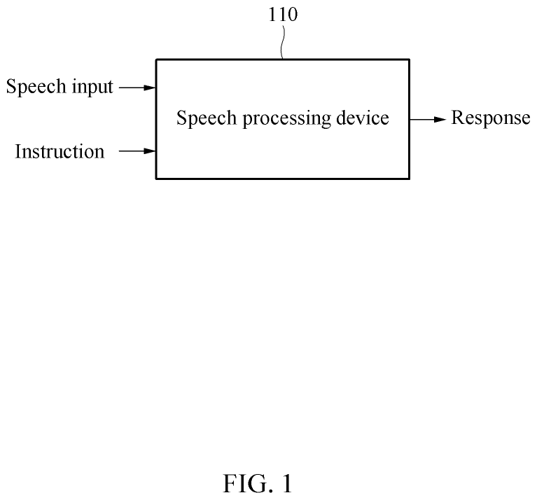

FIG. 1 illustrates an example of a speech processing system, according to one or more embodiments.

Referring to FIG. 1, a speech processing system is a system that may be configured to receive and use a speech form (e.g., audio data of human speech) as an input and generate a related response. For example, a speech processing system may perform speech recognition, speech emotion recognition, speaker recognition, speech translation, colloquial language understanding, and/or the like.

A speech input is a human voice or speech sound (in the form of data) and may be distinguished from general audio input, which refers to all types of sounds that may be sensed by the ears. The PandaGPT model and MACAW-LLM, according to the related art, have a limitation in that the PandaGPT model and the MACAW-LLM may process a task related to an audio input but may not process a task related to a speech input. Furthermore, the ImageBind-LLM, according to the related art, only improves an ability to understand an audio input by using an output of a separate speech recognition expert (speech recognition is not integrated into the model).

A general-purpose speech processing system may be built using a language model, and may respond to a speech input. The speech processing system may include a speech processing device 110 as a main agent. The speech processing device 110 may receive an instruction related to a speech input and generate a response. Furthermore, the speech processing system is a general-purpose speech processing system, and may perform a variety of speech related tasks (e.g., gender recognition, speech recognition, emotion recognition, etc.).

Assume, as an example, that the speech processing device 110 receives a waveform (a speech input) in which a female speaker happily utters “Hello” as a speech input. The speech processing device 110 may receive instructions such as “What is the gender of the speaker?,” “What is the content the speaker utters?,” “How many speakers are there?,” “Tell me how the speaker feels,” etc., and may output responses such as “The speaker is a woman,” “The speaker is in a state of joy,” and “There is only one speaker”.

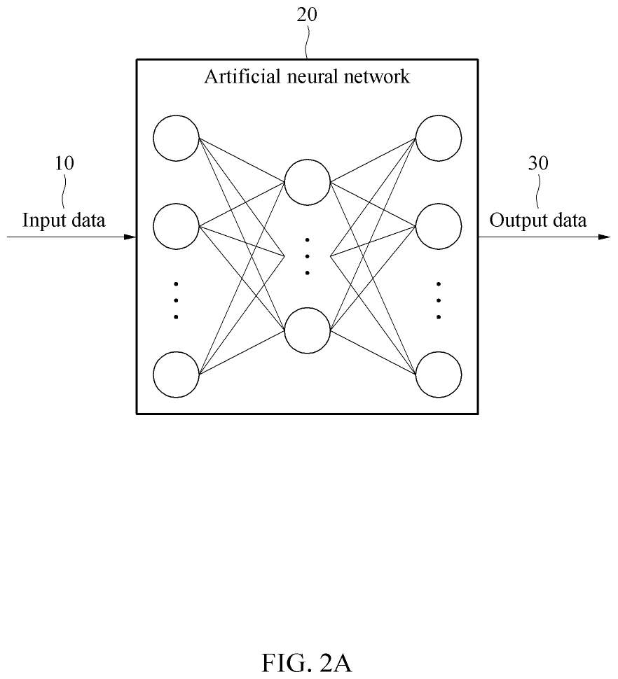

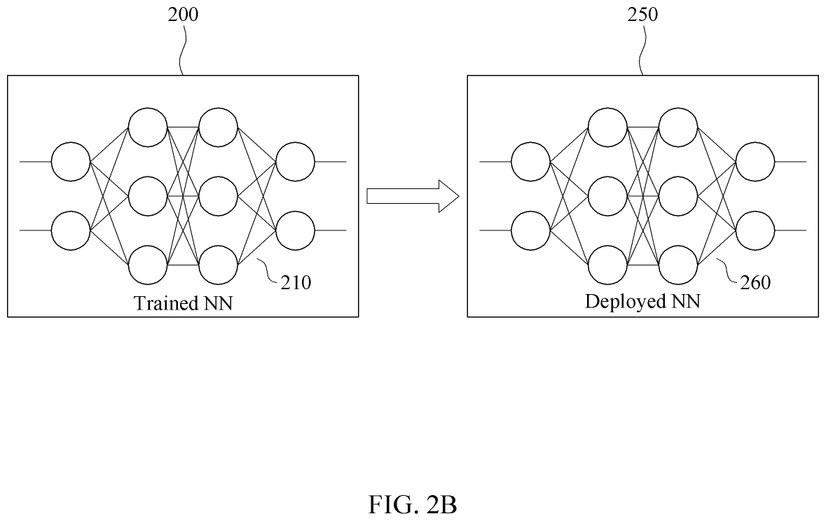

The speech processing system may include the speech processing device 110 based on a neural network model, and the speech processing device 110 may be trained to output a response corresponding to an instruction related to a speech input. The overall operation of a neural network model is described below with reference to FIGS. 2A and 2B.

FIG. 2A illustrates an example of a deep learning operation method using a neural network, according to one or more embodiments.

An artificial intelligence (AI) algorithm including deep learning or the like is characterized in that input data 10 is input to a neural network 20 and the neural network 20 performs inference, based on state of the neural network 20 (e.g., weights of connections between nodes) to generate an output data 30. The neural network 20 may include layers of nodes, including an input layer, one or more hidden layers, and an output layer, for example. Except the input layer, each layer's nodes may have connections to a preceding layer's nodes. The connections may have respective weights that are learned by various training methods. The neural network 20 may be implemented as various neural network architectures, for example, a convolutional neural network (CNN), a recurrent neural network (RNN), a deep belief network (DBN), and a restricted Boltzmann machine (RBM) model, to name some non-limiting examples. In a feed-forward neural network, neurons may have links to other neurons. Such links may extend through the neural network in one direction, for example, in a forward direction.

FIG. 2A illustrates the input data 10 input to the neural network 20 and the output data 30 is output by the neural network 20 (e.g., a CNN) including at least one layer. The neural network 20 may be, for example, a deep neural network (DNN) including at least two layers.

In the case where the neural network 20 is implemented as a CNN, the CNN may extract features such as borders, lines, and colors from the input data 10 (e.g., an image). The CNN may include multiple layers. Each of the layers may receive data, process the received data, and may generate data that is to output to a next layer. Data output from a layer may be a feature map generated by performing a convolution operation on an image or a feature map, specifically, convolving a filter (including one or more weights) over the image or feature map. Initial layers of the CNN may operate to extract low-level features such as edges or gradients from an input. Subsequent layers of the CNN may extract gradually more complex features higher level features such as the eyes and nose in an image.

FIG. 2B illustrates an example of a training and inference method of a neural network model, according to one or more embodiments.

Referring to FIG. 2B, the speech processing system may include a training device 200 and an inference device 250. The training device 200 may correspond to a computing device having various processing functions, for example, functions of generating a neural network, training (or learning) a neural network, or retraining a neural network. For example, the training device 200 may be implemented as various types of devices such as a personal computer (PC), a server device, a mobile device, and the like.

The training device 200 may generate a trained neural network 210 by repetitively training (or learning) a given initial neural network. Generating the trained neural network 210 may involve determining neural network parameters. These parameters may include various types of data, for example, input/output activations, weights (noted above), and biases that are input to and output from a neural network. When the neural network is repeatedly trained, the parameters of the neural network may be tuned to enable the neural network to calculate a more accurate output for a given input.

The training device 200 may transmit the at least one trained neural network 210 to the inference device 250. The inference device 250 may be the speech processing device 110 described above with reference to FIG. 1. The inference device 250 may be included in, for example, a mobile device or an embedded device. The inference device 250 may be or may include a hardware device configured for driving a neural network and may be an electronic device including at least one of a processor, a memory, an input/output (I/O) interface, a display, a communication interface, or a sensor.

The inference device 250 may include, or be included in, any digital device that includes a memory means and a microprocessor and has a computation capability, such as a tablet PC, a smartphone, a PC (e.g., a notebook computer, etc.), an AI speaker, a smart television (TV), a mobile phone, a navigation device, a web pad, a personal digital assistant (PDA), a workstation, or the like.

The inference device 250 may drive the trained neural network 210 as-is, or may drive a neural network 260 derived by quantization, for example, of the trained neural network 210. The inference device 250 for operating the neural network 260 may be implemented in a separate device independent of the training device 200. However, examples are not limited thereto, and the inference device 250 and the training device 200 may be one and the same.

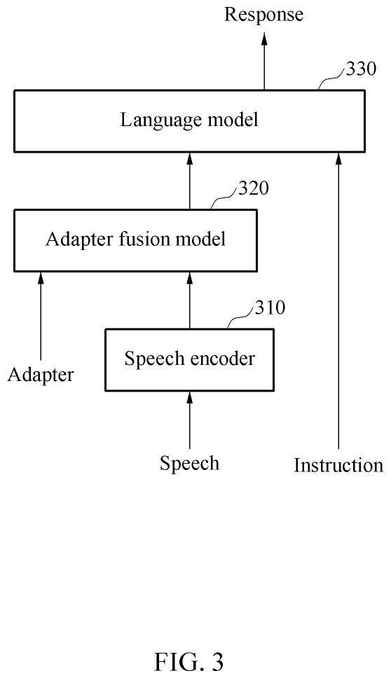

FIG. 3 illustrates an example of a structure of a speech processing device, according to one or more embodiments.

The description provided with reference to FIGS. 1 to 2B is generally applicable to the examples of FIG. 3. Referring to FIG. 3, a speech processing device (e.g., the speech processing device 110 of FIG. 1) may include a speech encoder 310, an adapter fusion model 320, and a language model 330. However, not all the illustrated components are essential and the functionalities and techniques described herein may be implemented with different network architectures. The speech processing device may be implemented by more or less components than the illustrated components.

The speech encoder 310 may receive a speech input (audio data of human voice) and may output a speech representation corresponding to, and based on, the speech input. More specifically, the speech encoder 310 may receive a speech input, e.g., a raw speech signal sequence, and, each time it receives a speech input it may encode the speech input as an output speech representation. The speech representation may also be referred to as a feature vector. The speech encoder 310 may be, for example, a self-supervised learning (SSL) model such as WavLM, Wav2vec 2.0, etc.

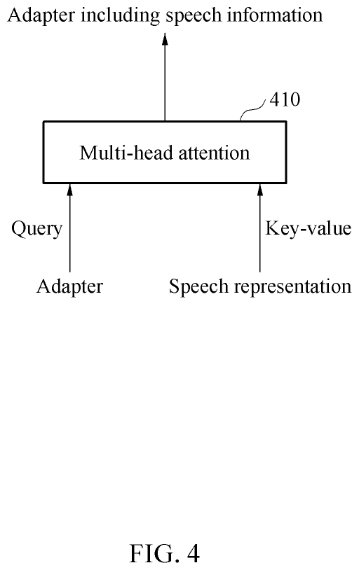

The adapter fusion model 320 may be a model that generates an adapter that includes speech information by fusing an input/pre-trained adapter with the speech representation. The operations of the adapter fusion model 320 are described in detail below with reference to FIG. 4.

The language model 330 may be a neural network model trained to understand and generate human language. For example, the language model 330 may be a large language model (LLM). An LLM may learn large-scale language data, and understand and generate a sentence structure, grammar, meaning, and other meanings inherent in words. For example, the language model 330 may be LLAMA 2. Generally, the language model 330 is text based and is trained on a large corpus of texts of a same human language and learns limited understanding about the human language.

The training of the speech processing device may include training of the language model 330, which is a backbone model, training of the speech encoder 310, and training of an adapter that is input to the adapter fusion model 320. A training device (e.g., the training device 200 of FIG. 2B) may train the language model 330, the speech encoder 310, and the adapter. The models may be trained one at a time or at the same time.

In the case of the language model 330, the training device may train the language model 330 from scratch using a training objective corresponding to each trained LLM. However, training the language model 330 from scratch may require large computational resources. Accordingly, the speech processing device may use a pre-trained LLM.

In the case of the speech encoder 310, the training device may train the speech encoder 310 using an objective function of whichever SSL model is employed. For example, in the case of Wav2vec 2.0, contrastive loss may be used as an objective function, and in the case of HuBERT, loss of MLM-style may be used as an objective function.

The training device may generate an instruction-response dataset based on known datasets (e.g., LibriSpeech, IEMOCAP, etc.) of speech-related tasks. The instruction and response may each be in the form of a natural language. For example, the training device may generate an instruction-response dataset, for example a first instruction-response may be “Please specify the speaker's gender”—“The speaker's gender is female”, and another instruction-response may be “Can you share with me what the speaker is exactly saying?”-“The exact utterances made by the speaker are Do you need any soap queried Rebecca Do I look as if I did he responded unexpectedly Rebecca dimpled I didn't mean that I have some soap to sell.”

The instruction-response dataset may be used by the training device to train models included in the speech processing device based on a speech input. Alternatively, the training device may use the language model 330 trained in advance and the speech encoder 310 trained in advance as described above. In this case, the training device may perform fine-tuning on the models included in the speech processing device based on the language model 330 and the speech encoder 310.

More specifically, the training device may freeze (not update) the language model 330 (which has been trained in advance) and freeze the speech encoder 310 (also trained in advance) and may instead train only an adapter (a set of values described below). Through this, there may be an effect similar to training the entire model but by only training a small number of parameters (e.g., in the adapter). The adapter is a parameter to be fine-tuned, and may be in the form of a tensor. The adapter may be referred to as a learnable adaptation prompt (learning of the adapter is described next).

The training device may input the adapter and the speech representation (from the speech encoder 310) to the adapter fusion model 320, which may fuse those inputs to generate and output the earlier-mentioned adapter that includes the speech information (to be distinguished from the trained adapter that is inputted to the adapter fusion model 320). The adapter that includes the speech information and an instruction may both be inputted to the language model 330, which may generate (infer) and output a corresponding response. The training device may train the adapter based on a difference between the response that is outputted from the language model 330 and a labeled response that is included in the instruction-response dataset. For example, the training device may adjust a value of the adapter in a direction in a direction that minimizes the difference between the response outputted from the language model 330 and the labeled response included in the instruction-response dataset.

The adapter fusion model 320 is supposed to fuse the adapter and the speech representation. However, since the adapter has a fixed length but the speech representation has a variable length, thus, the sizes of two inputs of the adapter fusion model 320 may be matched to facilitate fusion.

When the adapter and an image representation are the inputs to be fused, the sizes of the two inputs may be aligned by slicing the image representation to match the size of the adapter. However, unlike an image representation, a speech representation has a variable length, which may be relatively long compared to that of the adapter, so slicing the speech representation may lead to too much loss of information.

Accordingly, the adapter fusion model 320 may generate an output (the adapter with fused-in speech information) having the same length as that of the adapter by fusing the adapter and the speech representation through multi-head attention.

FIG. 4 illustrates an example of an adapter fusion model, according to one or more embodiments.

Referring to FIG. 4, an adapter fusion model (e.g., the adapter fusion model 320 of FIG. 3) may include multi-head attention 410. The multi-head attention 410 may be configured to receive a query and a key-value as an input.

The multi-head attention 410 may use a fixed-length adapter as a query and may use a speech representation as a key-value. Output data of the multi-head attention 410 may have the same length as that of the query. Accordingly, when the adapter is used as a query, the multi-head attention 410 may generate an output (another adapter) having the same length as that of the adapter/query.

Furthermore, in the multi-head attention 410, the key may refer to hidden vectors of a speech encoder (e.g., the speech encoder 310 of FIG. 3) that should be checked for its relevance with the query, and the value may refer to hidden vector values retrieved from the speech encoder by the key. Accordingly, an adapter that includes speech information, which is an output of the multi-head attention 410, may have the same length as that of the adapter yet still include the speech information.

When training of the adapter is completed, a speech processing device may store the trained adapter. For example, the speech processing device may store the trained adapter in the adapter fusion model (since the trained adapter is always on of the two inputs to be fused). In the inferencing stage, the adapter fusion model may fuse the stored adapter and a speech representation corresponding to a speech input of a user.

In FIG. 4, an example of using the multi-head attention 410 as the adapter fusion model is described but the adapter fusion model is not necessarily limited thereto. For example, various types of models that use an attention function may be adopted as the adapter fusion model.

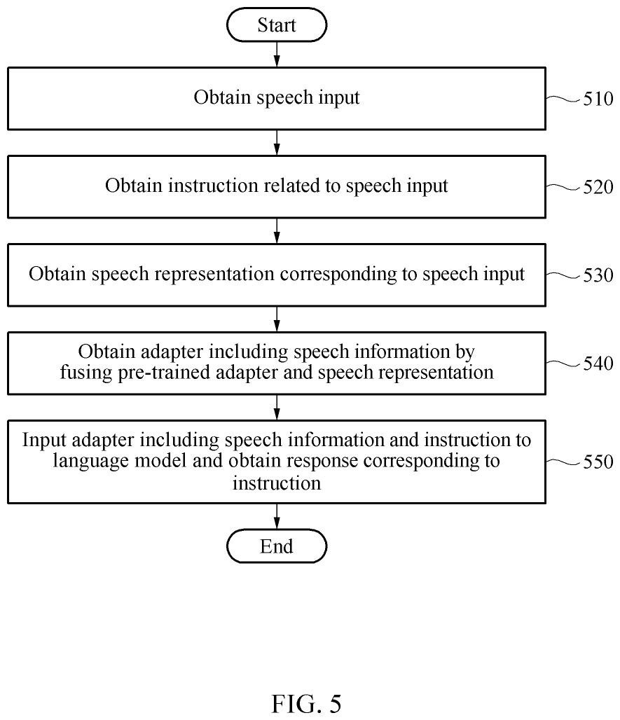

FIG. 5 illustrates an example of a speech processing method, according to one or more embodiments.

For convenience of description, operations 510 to 550 are described as being performed using the speech processing device described above with reference to FIGS. 1 to 3. However, operations 510 to 550 may be performed by another suitable electronic device in a suitable system.

Furthermore, the operations of FIG. 5 may be performed in the shown order and manner. However, the order of some operations may be changed or omitted without departing from the spirit and scope of the shown example. The operations shown in FIG. 5 may be performed in parallel or simultaneously.

Referring to FIG. 5, in operation 510, a speech processing device may obtain a speech input (e.g., audio signal data of a voice). The speech processing device may include a sensor and directly receive a speech input of a speaking person through the sensor. Alternatively, the speech processing device may receive a speech input from another device.

In operation 520, the speech processing device may obtain an instruction related to a speech input. The speech processing device may include an input interface (e.g., a keyboard) and directly receive an instruction through the input interface. Alternatively, the speech processing device may receive an instruction from another device. The instruction may be in the form of natural language text. The instruction may be an instruction related to at least one of, with respect to the speech input, speech recognition, speech emotion recognition, speaker recognition, speech translation, or colloquial language understanding related to the speech input, to name some examples.

In operation 530, the speech processing device may obtain a speech representation corresponding to a speech input. The speech processing device may input the speech input to a speech encoder and obtain the speech representation corresponding to the speech input. The speech representation may have a variable length.

In operation 540, the speech processing device may obtain an adapter that includes speech information by fusing a pre-trained adapter with a speech representation. The speech processing device may include multi-head attention, input the pre-trained adapter as a query of the multi-head attention, and input the speech representation as a key-value of the multi-head attention. The speech processing device may use an output of the multi-head attention as the adapter that includes the speech information. The adapter that includes the speech information may have the same length as that of the pre-trained adapter.

In operation 550, the speech processing device may input both the adapter that includes the speech information and an instruction to a language model and may obtain from the language model a response corresponding to the instruction. The speech processing device may include an output interface and may output a response through the output interface. Alternatively, the speech processing device may transmit the response to another device. The response may be, as with the instruction, in the form of natural language text. The response may be a response related to, with respect to the speech input, at least one of speech recognition, speech emotion recognition, speaker recognition, speech translation, or colloquial language understanding related to the speech input, to name some examples.

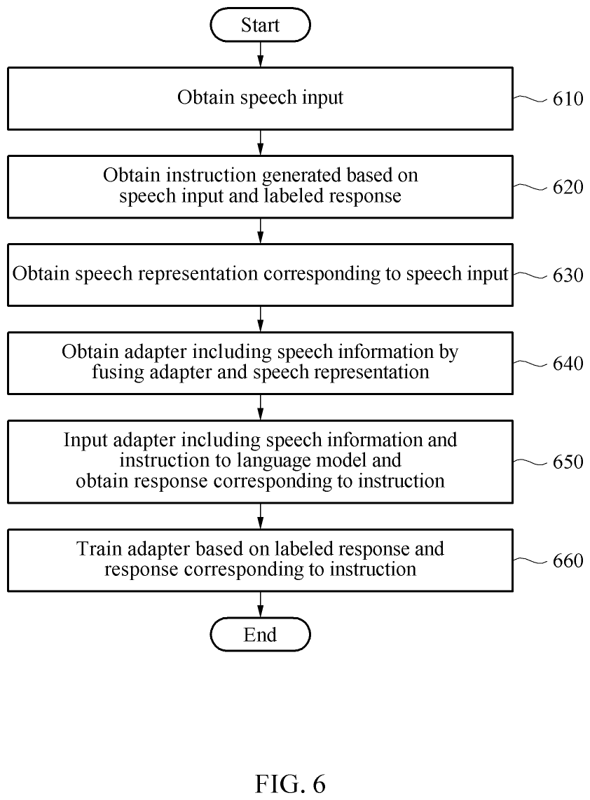

FIG. 6 illustrates an example of a training method, according to one or more embodiments.

For convenience of description, operations 610 to 660 are described as being performed using the training device described above with reference to FIGS. 1 to 3. However, operations 610 to 660 may be performed by another suitable electronic device in a suitable system.

Furthermore, the operations of FIG. 6 may be performed in the shown order and manner. However, the order of some operations may be changed or omitted without departing from the spirit and scope of the shown example. The operations shown in FIG. 6 may be performed in parallel or simultaneously.

Referring to FIG. 6, in operation 610, a training device may obtain a speech input.

In operation 620, the training device may obtain an instruction generated based on the speech input and a labeled response.

The instruction and the labeled response may be generated using a language model. Through this, an instruction-response dataset may have a colloquial form. The instruction and response may be generated in the form of respective sets of elements. For example, a set of instructions asking how the speaker feels may include elements such as “How does the speaker currently feel?,” “What is the emotional state of the speaker?,” “What is the feeling of the speaker?,” etc. In addition, a set of responses corresponding to the instructions may include elements such as “The speaker's voice radiates with happiness and joy,” “A contagious sense of happiness emanates from the speaker's tone,” “From the cheerful tone of the speech, it's evident the speaker is feeling elated,” etc.

In operation 630, the training device may obtain a speech representation corresponding to a speech input. The training device may input the speech input to a speech encoder and obtain the speech representation corresponding to the speech input. The speech representation may have a variable length.

In operation 640, the training device may obtain an adapter that includes speech information by fusing an adapter with a speech representation. The training device may include multi-head attention. The adapter may be inputted to the multi-head attention as a query of the multi-head attention, and may input the speech representation as a key-value of the multi-head attention. The speech processing device may determine an output of the multi-head attention to be the adapter that includes the speech information. Here, the adapter that includes the speech information may have the same length as that of the adapter.

In operation 650, the training device may input both the adapter that includes the speech information and an instruction to a language model and may obtain a response corresponding to the instruction.

In operation 660, the training device may train the adapter based on a labeled (ground truth) response and the response corresponding to the instruction.

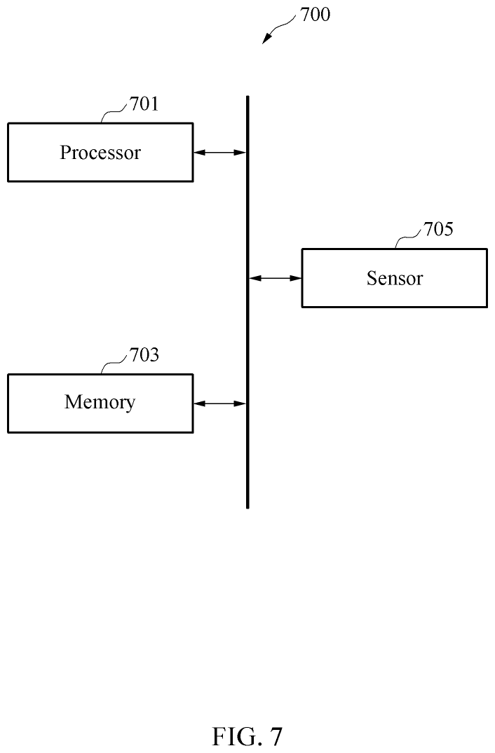

FIG. 7 illustrates an example of a configuration of an electronic device, according to one or more embodiments.

Referring to FIG. 7, an electronic device 700 may include a processor 701, a memory 703, and a sensor 705. The electronic device 700 may be a speech processing device described above with reference to FIGS. 1 to 5.

The processor 701 may perform at least one operation described above with reference to FIGS. 1 to 5. The processor 701 may receive a speech input, output a speech representation corresponding to the speech input, output an adapter including speech information by fusing a pre-trained adapter and the speech representation, receive an instruction related to the speech input and the adapter including the speech information, and output a response corresponding to the instruction.

The memory 703 may be a volatile memory or a non-volatile memory, and the memory 703 may store data (e.g., parameters of a speech encoder for which training is completed, a fusion model, and an adapter) required to perform a computational restoration.

The sensor 705, e.g., a microphone, may receive a speech input.

The electronic device 700 may further include other components not shown in the diagram. For example, the electronic device 700 may further include an I/O interface including an input device and an output device as the means for interfacing with a communication module. In addition, for example, the electronic device 700 may further include other components such as a transceiver, various sensors, and a database.

The examples described herein may be implemented using a hardware component, a software component, and/or a combination thereof. A processing device may be implemented using one or more general-purpose or special-purpose processors, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The computing apparatuses, the electronic devices, the processors, the memories, the sensors, the displays, the information output system and hardware, the storage devices, and other apparatuses, devices, units, modules, and components described herein with respect to FIGS. 1-7 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-7 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A method of processing speech, the method comprising:
obtaining a speech input;
obtaining an instruction related to the speech input;
obtaining a speech representation corresponding to the speech input;
obtaining an adapter that includes speech information by fusing a pre-trained adapter with the speech representation; and
obtaining a response corresponding to the instruction by inputting both the adapter that includes the speech information and the instruction to a language model.

2. The method of claim 1, wherein the adapter that includes the speech information and the pre-trained adapter have a same length.

3. The method of claim 1, wherein the obtaining of the adapter that includes the speech information comprises:
inputting the pre-trained adapter as a query of a multi-head attention;
inputting the speech representation as a key-value to the multi-head attention; and
determining an output of the multi-head attention to be the adapter that includes the speech information.

4. The method of claim 1, wherein the pre-trained adapter has a fixed-length, and the speech representation has a variable length.

5. The method of claim 1, wherein the speech representation is obtained by inputting the speech input to a speech encoder.

6. The method of claim 1, wherein the response comprises, with respect to the speech input, a speech recognition, a speech emotion recognition, a speaker recognition, a speech translation, or colloquial language understanding related to the speech input.

7. A training method comprising:
obtaining a speech input;
obtaining an instruction generated based on the speech input and a labeled response;
obtaining a speech representation corresponding to the speech input;
obtaining an adapter that includes speech information by fusing an adapter and the speech representation;
obtaining a response corresponding to the instruction by inputting the adapter that includes the speech information and the instruction to a language model that generates the response corresponding to the instruction; and
training the adapter based on the labeled response and the response corresponding to the instruction.

8. The training method of claim 7, wherein the speech representation is obtained by inputting the speech input to a speech encoder that generates the speech representation, the speech representation representing features of the speech input.

9. The training method of claim 8, wherein the language model and the speech encoder are pre-trained models.

10. The training method of claim 7, wherein the adapter that includes the speech information and the adapter fused with the speech representation have a same length.

11. The training method of claim 7, wherein the obtaining of the adapter that includes the speech information comprises:
inputting the adapter as a query of multi-head attention;
inputting the speech representation as a key-value of the multi-head attention; and
determining an output of the multi-head attention to serve as the adapter that includes the speech information.

12. The training method of claim 7, wherein the adapter has a fixed-length, and the speech representation has a variable length.

13. A non-transitory computer-readable storage medium storing instructions that, when executed by a processor, cause the processor to perform the method of claim 1.

14. A device for processing speech, the device comprising:
a speech encoder configured to receive a speech input and configured to encode the speech input as a speech representation corresponding to the speech input;
a fusion model configured to output an adapter that includes speech information by fusing a pre-trained adapter and the speech representation; and
a language model configured to receive an instruction related to the speech input and the adapter including the speech information, the language model configured to output a response corresponding to the instruction.

15. The device of claim 14, wherein the adapter including the speech information and the pre-trained adapter have a same length.

16. The device of claim 14, wherein the fusion model is configured to:
receive the pre-trained adapter as a query of a multi-head attention;
receive the speech representation as a key-value of the multi-head attention; and
output an output of the multi-head attention to the adapter comprising the speech information.

17. The device of claim 14, wherein the pre-trained adapter has a fixed-length, and the speech representation has a variable length.
